(19) United States
(12) Patent Application Publication
(10) Pub. No.: US 2003/0091278 A1
(43) Pub. Date: May 15, 2003

(54) Device for focusing a laser beam exiting from a glass fiber

(76) Inventor: Karl Erich Albert Schaschek, Thungen (DE)

Correspondence Address: Douglas R Hanscom, Jones Tullar & Cooper, Eads Station, PO Box 2266, Arlington, VA, 22202, US

(21) Appl. No.: 10/240,735

(22) PCT Filed: Apr. 6, 2001
(86) PCT No.: PCT/DE01/01349

(30) Foreign Application Priority Data
Apr. 14, 2000 (DE) 100 18 546.0

(51) Int. Cl. G02B 6/32

(52) U.S. Cl. 385/33

(57) ABSTRACT

Imaging on an offset printing plate is accomplished with the aid of laser beams. The laser beams are produced by laser diodes and are conducted to the offset printing plate by glass fibers and are formed onto the offset printing plate by lenses or lens arrangements to produce picture elements. In order to provide compact lenses or lens arrangements, a fresnel lens or a holographic lens is utilized.

The invention relates to a device in accordance with the preamble of claim 1 for focusing a laser beam exiting from a glass fiber.

It is known to employ laser diodes of different output strengths for processing surfaces, and in particular for applying images to offset printing plates. In the course of this, laser diodes are employed which generate laser beams which are located close to the infrared range.

Offset printing plates, to which images are being applied, consist of a substrate on the basis of plastic, which is altered, for example by being treated with laser light, in such a way that it gains an affinity to printing ink or repels it in the areas or spots where it was treated. Thus, an affinity to oil-containing printing ink, or water-repellent (hydrophobic) areas or spots, is being created by means of the laser beam treatment. Besides this alteration of the surface, areas or spots of the latter can also be altered in other ways, or stripped, by means of this treatment with laser light. To alter, or strip, the surface of an offset printing plate, for example, it is necessary to focus the laser beam being emitted from a laser diode and being conducted through a glass fiber or other suitable optical fiber to the application location, in order to achieve the required energy density. The laser beam from a laser diode introduced into a glass fiber exits the diode divergently, wherein the angle of divergence is 5° to 25°. Therefore, in order to generate the required energy density on the surface to be worked it is necessary to focus the laser beam exiting the glass fiber.

It is known to use a common optical device, or an arrangement of several micro-lenses, for a glass fiber bundle conducting the laser beams.

It is known from EP 0 580 394 A2 and EP 0 620 670 A1 to apply images by means of laser beams to substrates constituting offset printing plates in that the laser beam, which divergently exits the laser diode, is bundled by means of a first optical device and introduced into a glass fiber, and thereafter the laser beam which divergently exits from the glass fiber is focused by means of an optical glass lens device with a plurality of lenses onto the offset printing plate. Besides expensive optical lens systems, the known optical systems for focusing laser beams require considerable structural space, which is often difficult to provide. Because of the required structural space, the number of diodes and the glass fibers conducting the laser beams is basically limited, so that the processing, or image application output is reduced because of this. In order to reduce the processing, or image application time, the available output must be increased. Since basically laser diodes only have a limited output, which is not capable of being increased, the processing, or image application time can only be reduced by an increase in the number of the laser diodes. However, with the known systems the increase of the number of laser diodes which simultaneously act on the surface is limited by the optical systems used for focusing.

DE 38 33 096 A1 and JP 63-33717 A describe the use of Fresnel lenses in arrangements for coupling optical wave guides.

The invention is based on the object to provide a device for focusing a laser beam exiting a glass fiber, by means of which the image-application time on printing plates can be reduced.

In accordance with the invention, this object is attained by the characteristics of claim 1.

It is intended in particular to create a device of the type mentioned at the outset, by means of which surfaces, preferably offset printing plates, can be worked, or images applied to them, with a justifiable expenditure and high output.

In accordance with the invention, in a device of the type mentioned at the outset this object is attained in that the lens, or the lens arrangement is constituted by a Fresnel lens or a holographic lens.

Fresnel lenses (Fresnel zone plates) or holographic lenses are distinguished in that they consist of flat thin plates or foils, so that they can be arranged in a space-saving manner. Moreover, Fresnel lenses and holographic lenses can be cost-effectively produced in large numbers, or can be copied from a master lens, so that the arrangement in accordance with the invention not only makes possible a space-saving installation, but also results in a considerable cost savings in comparison with known optical lens systems.

The Fresnel lenses or holographic lenses can be applied by means of an etching process directly onto the flat front, or outlet side of the fiber extending at right angles in relation to the fiber axis. The Fresnel lens or the holographic lens can be applied to a thin transparent substrate by means of LIGA technology (lithography, electro-forming and shaping). LIGA technology makes possible the production of highly precise, three-dimensional micro-structures from various materials in large numbers. In the course of this, a radiation-sensitive polymer layer, for example a photoresist, whose thickness can be a few micrometers to a few millimeters, is applied in the lithographic step to an electrically conductive substrate plate and is provided with a structure by means of exposing it to an energy-rich radiation, as well as a subsequent wet-chemical development. In accordance with a preferred embodiment it is therefore provided that the Fresnel lens or holographic lens in accordance with LIGA technology is cut into a flat transparent substrate and is connected with the flat front, or outlet side of the fiber extending at right angles in relation to the fiber axis.

The holographic lens can be produced in a known manner as a transmission hologram (for example, see Tschudi and Ammann in “Praxis der Holografie” [Practical Holography], publ. by expert verlag, 7044 Ehingen, 1990, pp. 458 to 460). It is then possible to produce copies of the master hologram containing the holographic lens in accordance with a known copying process, which can then be connected with the outlet sides of the glass fiber.

1. A device for focusing a laser beam exiting from a glass fiber for applying images to an offset printing plate, wherein laser diodes which generate laser beams are arranged and a lens or lens arrangement is provided at the outlet end of the glass fiber, characterized in that the lens or lens arrangement has a Fresnel lens or a holographic lens.

2. The device in accordance with claim 1, characterized in that the Fresnel lens or holographic lens is cut by means of an etching process on the flat front or outlet side of the glass fiber extending at right angles in relation to the fiber axis.

3. The device in accordance with claim 1, characterized in that the Fresnel lens or holographic lens is cut into a flat transparent substrate and is connected with the flat front or outlet side of the glass fiber extending at right angles in relation to the fiber axis.

4. The device in accordance with claim 3, characterized in that the flat transparent substrate is produced in accordance with LIGA technology.
